(19) United States
(12) Patent Application Publication
(10) Pub. No.: US 2008/0250596 A1
(43) Pub. Date: Oct. 16, 2008

(54) Wiper Blade

(75) Inventor: Godelieve Kraemer, Huegelsheim (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 11/720,902

(22) PCT Filed: Oct. 19, 2005
(86) PCT No.: PCT/EP05/55360

§ 371 Date: Sep. 6, 2007

(30) Foreign Application Priority Data
Dec. 6, 2004 (DE) 10 2004 058 685.3

(51) Int. Cl. B60S 1/40; B60S 1/04

(52) U.S. Cl. 15/250.32; 15/250.001

(57) ABSTRACT

The invention starts from a wiper blade, which is constructed of a rubber profile (12) with a wiper lip (16) and at least one supporting element (20), which can be connected in its center region in an articulated manner to one end of a wiper arm via a connecting device (22), wherein the connecting device (22) with claws (26) clasps the supporting element (20) laterally and from the side, which is facing the wiper lip (16), and is secured in the axial direction on a wiper strip (10) of the wiper blade. It is proposed that the connecting device (22) have on one side, which faces a top strip (14) of the wiper strip (10), a compartment (36), whose wall that is adjacent to the top strip (14) is configured as a resilient clip (38), which in a mounted state is pressed against the top strip (14) by a bracket (42), which is inserted from a front side into the compartment (36).

### PRIOR ART

The invention starts with a wiper blade according to the pre-characterizing clause of claim 1.

A windshield wiper with a wiper blade, which is connected in an articulated manner to a wiper arm via a so-called sidelock system, is known from DE 199 24 662 A1. In this case, a connecting element, which clasps the spring rails of the wiper blade that serve as a supporting element laterally and from below with formed-on form-closure elements. A cap made of plastic covers the connecting element that is fabricated of sheet metal as a rule and is also designated as a sheet metal claw, because its formed-on claws are pressed against the supporting element during assembly and thus secured via frictional connection in the longitudinal direction of the supporting element. Fastenings via welding or adhesion are also known. A connecting element connected to the free end of the wiper arm, e.g., of a wiper rod of the wiper arm, has a bearing pin, which is inserted into the connecting element laterally and transverse to the longitudinal direction of the wiper am and pointing towards the wiper blade and is preferably welded or riveted. The bearing pin is pivoted in a bearing bore hole of the connecting element. The connecting element can be fabricated with the bearing pin and a securing element in the form of a bow separately in one piece using casting or injection molding technology and be slid onto the end of the cross-sectionally rectangular wiper rod of the wiper arm and be fastened there.

The bow is arranged parallel to the bearing pin on the connecting element in the longitudinal direction offset towards the drive end and said bow is bent on its free end towards the side of the wiper blade. In an assembly position, in which the wiper blade is held transverse to the longitudinal direction of the wiper arm, the bearing pin can be inserted into a bearing bore hole of the connecting element. If the wiper blade is then rotated parallel to the longitudinal direction of the wiper arm, the bow grips over the cap and the connecting element and locks it with its bent end so that lateral guide surfaces of the cap are guided in a mounted state between the bent end of the bridge element and an opposing surface of the connecting element. In the wiper blade's operating position, the bow dips into a corresponding groove on the upper side of the cap and terminates approximately flush. For disassembly, the wiper blade must be swiveled in the opposite direction until the bent end is disengaged and the wiper blade can be pulled from the bearing pin. The wiper blade has a spoiler on its upper side. It increases the application pressure of the wiper blade against the vehicle window with increasing air stream wind.

A windshield wiper is known from DE 197 57 872 A1 whose wiper arm is detachably connected on its free end via an articulated connection to a non-articulated wiper blade in accordance with a type of toplock connection. The articulated connection has a first coupling part, which is fastened on a supporting element of the wiper blade and on its front side has an articulation axis in the form of two laterally arranged bearing pins. On its end opposing the articulation axis, the first coupling part has counter bearing surfaces, which point towards the articulation axis and with bearing surfaces on a second coupling part form a counter bearing.

The second coupling part has an open hub on its front side, which is provided in lateral guide walls and in which the bearing pins of the first coupling part are positioned in a mounted state. The second coupling part is fastened with its end opposite from the open hub fastened on a wiper arm. The open hub points offset parallel to the wiper arm in the direction of its free end so that the first coupling part fastened on the wiper blade can be inserted parallel to the wiper arm between the lateral guide walls of the second coupling part until the lateral bearing pins come to bear on the bearing surfaces of the open hub. During assembly, the bearing surfaces belonging to the counter bearing, which are arranged in a laterally yielding manner on flexible tongues of the first coupling part, are pressed to the inside and move back again elastically to the outside into the old position as soon as they have passed the corresponding bearing surfaces on the second coupling part. The counter bearing prevents the bearing pins in a mounted state from being pressed out of the open hub.

### ADVANTAGES OF THE INVENTION

According to the invention, the connecting device has on one side, which faces a top strip of the wiper strip, a compartment, whose wall that is adjacent to the wiper strip is configured as a resilient clip. Said clip is pressed in a mounted state against the top strip by a bracket. The bracket is inserted during assembly from a front side into the compartment. In this case, it is expedient for the clip to have a nose, which in a mounted state engages in the rubber elastic top strip. In order to simplify the assembly of the bracket, said bracket has on the front side, which is inserted into the compartment, a wedge shape, whose surfaces run inclined towards the top strip. Because of the wedge surfaces, the bracket can be inserted easily into the compartment and the clip can be pressed in the direction of the top strip. In a mounted state, the clip is adjacent to a flat surface of the bracket so that no force components can be generated against the assembly direction and press the bracket to the outside. As additional security, the bracket can have flexible tongues, which engage with locking elements in locking indentations of the compartment. As a result, the bracket is fixed in the compartment in the axial direction. For disassembly, the flexible tongues can be pressed back with a tool or possibly also pressed together by hand so that the bracket can be removed from the compartment as soon as the locking elements move out of their locking indentations.

The embodiment of the connecting device in accordance with the invention provides simple assembly, in which it is possible to dispense with welding, adhering or stamping processes in the region of the claws. Moreover, as a result the connecting device can be fabricated of a plastic, wherein claws are formed on the side walls. The side walls are connected to one another in the forward part by a front wall and on the drive-side end form, with a covering wall, the compartment, which is open towards the drive side. As a result, the connecting device in accordance with the invention does not require a cap to protect against dirt and corrosion or for reasons related to aerodynamics or design. The connecting device can have standard bearing elements, which are used for the articulated connection to the wiper arm according to the sidelock or toplock principle. One advantageous possibility is produced in that a bearing cylinder running transverse to the wiper blade is formed on the front wall, and said bearing cylinder has an opening towards the compartment for a correspondingly bent end of a wiper arm. The end of the wiper arm is threaded in through the opening and encircles the bearing cylinder according to the toplock principle.

### DRAWINGS

Additional advantages are yielded from the following description of the drawings. An exemplary embodiment of the invention is depicted in the drawings. The drawings, the description and the claims contain numerous features in combination. The person skilled in the art will also observe individual features expediently and combine them into additional, meaningful combinations.

The drawings show:

FIG. 1 A perspective partial view of a wiper strip of a wiper blade,

FIG. 2 A perspective view of a connecting device,

FIG. 3 A perspective view of a bracket,

FIG. 4 An exploded depiction of a partial longitudinal section of a wiper strip and a connecting device,

FIG. 5 A partial longitudinal section of a wiper strip and a connecting device with a bracket before assembly,

FIG. 6 A partial longitudinal section of a wiper strip with a mounted connecting device,

FIG. 7 A section corresponding to Line VII-VII in FIG. 6.

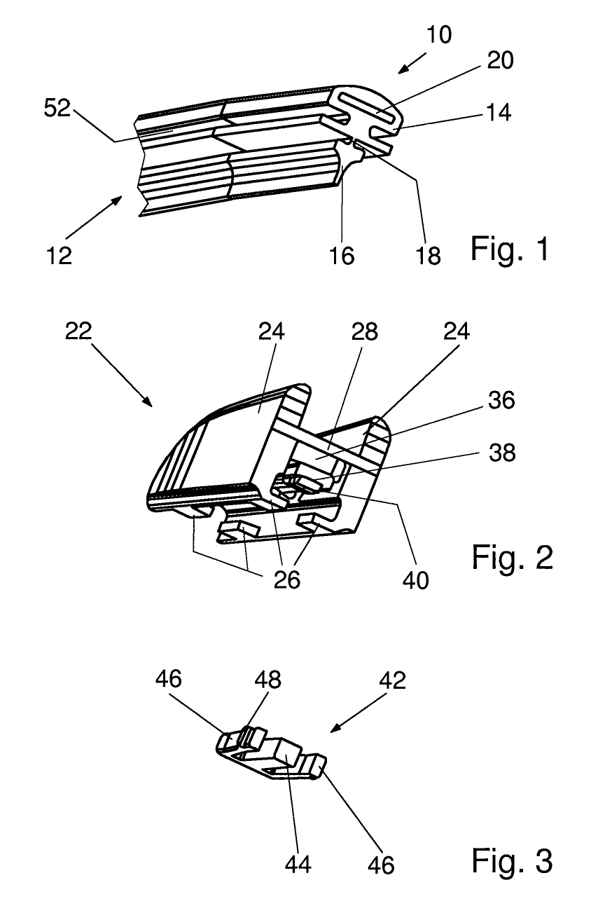

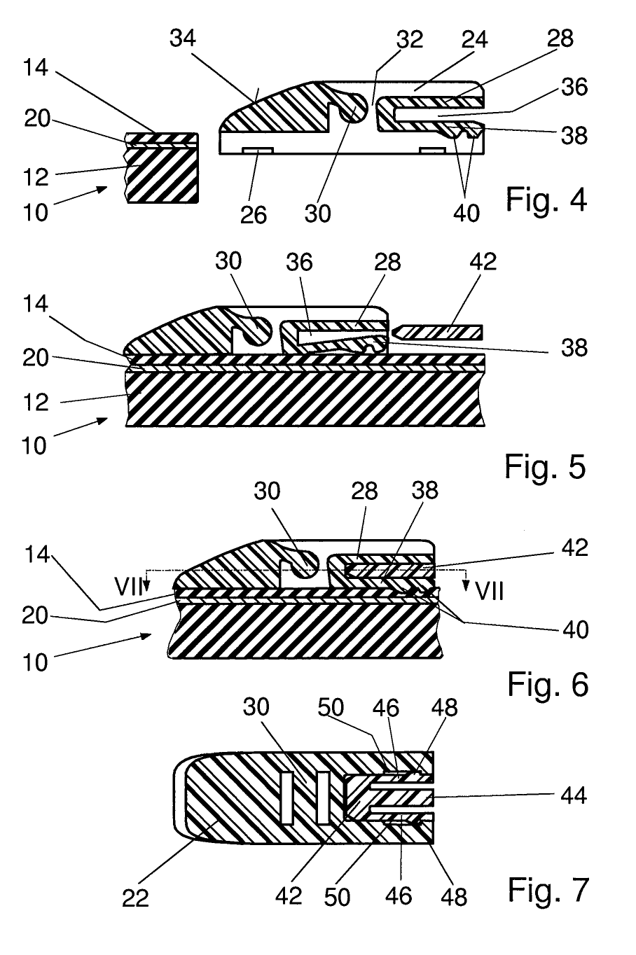

### DESCRIPTION OF THE EXEMPLARY EMBODIMENT

The wiper blade in accordance with the invention includes a wiper strip 10 and a connecting device 22, which is arranged approximately in the center of the wiper strip 10 and is used for the articulated connection to a wiper arm (not shown) according to the toplock principle. It is also possible, however, to provide the connecting device 22 with a bearing bore hole in order to connect the wiper blade to the wiper arm in an articulated manner according to the sidelock principle.

The wiper strip 10 is comprised essentially of a rubber profile 12 with a wiper lip 16, which is connected to a top strip 14 via a bridge 18. Arranged in a central channel of the top strip 14 is a spring rail 20, which serves as a supporting element for the wiper strip 10 and is pre-bent in such a way that it generates, under the application pressure of the wiper arm, a suitable distribution of pressure over the length of the wiper lip.

Two springs rails can also be provided instead of a central spring rail 20, which are inserted into two lateral grooves of the top strip 14. The connecting device 22, which as a rule can be comprised of a sheet metal claw and a cap, is a one-part piece and fabricated of plastic in the embodiment according to FIG. 2. Claws 26 facing the top strip 14 are formed on said connecting device's two side walls 24, which are connected to one another by a front wall 34 and a cover 28. These claws clasp the top strip 14 and the spring rail 20 by engaging in lateral longitudinal grooves 52 of the rubber profile 12. The spring rail 20 and the associated part of the top strip 14 are guided between the side walls 24.

The side walls 24 and the covering wall 28 form a compartment 36 that is open towards the front side, whose wall that runs parallel to the top strip 14 is configured as a resilient clip 38. Said clip is pressed during assembly against the spine of the top strip 14 by a bracket 42 so that the connecting device 22 is clamped and axially fixed between the claws 26 and the clip 38. The clip 38 has noses 40 towards the top strip 14, which during assembly of the bracket 42 press into the top strip 14 and thereby produce a form-fit connection in addition to a frictional connection.

For simplified assembly of the bracket 42, said bracket is sharpened in a wedge-shaped manner on the front side that lies forward in the assembly direction, wherein the wedge surfaces run inclined towards the spine of the top strip 14. As a result, the clip 38 can be pressed against the top strip 14 with low forces, while in a mounted state the clip 38 is adjacent to flat surfaces of the bracket 42 so that said bracket cannot slip out of the compartment 36 during operation. In addition, the bracket 42 is expediently secured by flexible tongues 46, which run lateral to a central block 44 of the bracket 42 and engage with locking elements 48 in locking indentations 50 of the compartment 36 (FIG. 7).

A bearing cylinder 30 serves as a bearing element for the articulated connection to a wiper arm. Said bearing cylinder is preferably formed on the front wall 34 facing the drive-side end and is connected on the front side to the side walls 24. It forms an opening 32 towards the walls of the compartment 36, through which opening a correspondingly formed end of the wiper arm can be threaded and encircle the bearing cylinder 30. In a mounted state, the end of the wiper arm is guided laterally between the inner sides of the side walls 24. Instead of the bearing cylinder 30 or in addition thereto, the connecting device 22 can have a hub, through which the wiper arm can be connected to the wiper blade according to the sidelock principle. If the connecting device 22 has only one hub, it is expedient for the front wall 34 to be guided up to the drive-side front wall so that a largely closed design is produced.

1. Wiper blade, which is constructed of a rubber profile (12) with a wiper lip (16) and at least one supporting element (20), which can be connected in an articulated manner to one end of a wiper arm via a connecting device (22), wherein the connecting device (22) with claws (26) clasps the supporting element (20) laterally and from the side facing the wiper lip (16), and is secured in the axial direction on a wiper strip (10) of the wiper blade, characterized in that the connecting device (22) has on a side facing a top strip (14) of the wiper strip (10), a compartment (36), whose wall that is adjacent to the top strip (14) is configured as a resilient clip (38), which in a mounted state is pressed against the top strip (14) by a bracket (42), which is inserted from a front side into the compartment (36).

2. Wiper blade according to claim 1, characterized in that the clip (38) has a nose (40), which in a mounted state engages the top strip (14).

3. Wiper blade according to claim 1, characterized in that the bracket (42) has on the front side, which is inserted into the compartment (36), a wedge shape, whose surfaces run inclined towards the top strip (14).

4. Wiper blade according to claim 1, characterized in that the bracket (42) has flexible tongues (46), which engage with locking elements (48) in locking indentations (50) of the compartment (36).

5. Wiper blade according to claim 1, characterized in that the connecting element (22) has side walls (24) on which the claws (26) are formed and are connected to one another in the forward part by a front wall (34) and on the drive-side end form, with a covering wall (28), the compartment (36), which is open towards the drive side.

6. Wiper blade according to claim 5, characterized in that a bearing cylinder (30) running transverse to the wiper blade is formed on the front wall (34), and said bearing cylinder has an opening (32) towards the compartment (36) for a correspondingly bent end of a wiper arm.

7. Wiper blade according to claim 2, characterized in that the bracket (42) has on the front side, which is inserted into the compartment (36), a wedge shape, whose surfaces run inclined towards the top strip (14).

8. Wiper blade according to claim 2, characterized in that the bracket (42) has flexible tongues (46), which engage with locking elements (48) in locking indentations (50) of the compartment (36).

9. Wiper blade according to claim 3, characterized in that the bracket (42) has flexible tongues (46), which engage with locking elements (48) in locking indentations (50) of the compartment (36).

10. Wiper blade according to claim 2, characterized in that the connecting element (22) has side walls (24) on which the claws (26) are formed and are connected to one another in the forward part by a front wall (34) and on the drive-side end form, with a covering wall (28), the compartment (36), which is open towards the drive side.

11. Wiper blade according to claim 3, characterized in that the connecting element (22) has side walls (24) on which the claws (26) are formed and are connected to one another in the forward part by a front wall (34) and on the drive-side end form, with a covering wall (28), the compartment (36), which is open towards the drive side.

12. Wiper blade according to claim 4, characterized in that the connecting element (22) has side walls (24) on which the claws (26) are formed and are connected to one another in the forward part by a front wall (34) and on the drive-side end form, with a covering wall (28), the compartment (36), which is open towards the drive side.

13. Wiper blade according to claim 2, characterized in that the bracket (42) has on the front side, which is inserted into the compartment (36), a wedge shape, whose surfaces run inclined towards the top strip (14).

14. Wiper blade according to claim 13, characterized in that the bracket (42) has flexible tongues (46), which engage with locking elements (48) in locking indentations (50) of the compartment (36).

15. Wiper blade according to claim 14, characterized in that the connecting element (22) has side walls (24) on which the claws (26) are formed and are connected to one another in the forward part by a front wall (34) and on the drive-side end form, with a covering wall (28), the compartment (36), which is open towards the drive side.

16. Wiper blade according to claim 15, characterized in that a bearing cylinder (30) running transverse to the wiper blade is formed on the front wall (34), and said bearing cylinder has an opening (32) towards the compartment (36) for a correspondingly bent end of a wiper arm.
